(19) United States
(12) Patent Application Publication
(10) Pub. No.: US 2026/0027798 A1
(43) Pub. Date: Jan. 29, 2026

(54) EXPANDABLE LAYERED PACKING PRODUCT

(71) Applicant: Ideabox Studios LLC, El Cerrito, CA (US)

(72) Inventor: Hetal Jariwala, El Cerrito, CA (US)

(21) Appl. No.: 19/276,921

(22) Filed: Jul. 22, 2025

Related U.S. Application Data
(60) Provisional application No. 63/674,994, filed on Jul. 24, 2024.

(51) Int. Cl. B31D 5/00; B31D 3/00

(52) U.S. Cl. CPC B31D 5/0065; B31D 3/002

(57) ABSTRACT

Expandable layered product are presented including: a first layer including, a first number of support tabs each defined by a continuous cut, where each of the first number of support tabs include a fold-line disposed along a longitudinal edge of the support tab, and where each of the first number of support tabs includes attachment points disposed along each end of the number of support tabs on a top surface of the first layer; and a second layer including, a second number of support tabs each defined by a continuous cut, where each of the second number of support tabs includes a second fold-line disposed along a longitudinal edge of the support tab, where each of the second number of support tabs includes attachment points along each end of the support tab on a bottom surface of the second layer.

### BACKGROUND

Shipping goods has always required packing materials to fill the voids between a container and to protect the goods within. Some examples of modern packing materials include: foam peanuts, bubble wrap, foam sheets, crumpled paper, and plastic air cushions, etc. More recently, the plastic and foam-based options have fallen out of favor because they are not biodegradable. Many companies are shifting to paper-based, more ecologically-sound and sustainable solutions. As such, the more ecologically friendly slitted paper packing has recently gained favor. This solution consists essentially of paper with rows of slits where every other row is offset. The slits allow the paper to be pulled apart and expanded along the slits to create a series of short, small roughly hexagonal cells. When the material is expanded, each of these cells is oriented with walls at an angle oblique to the general plane of the expanded material. While this has the advantage of being compact to transport and store, and provides some cushioning effect, it has a disadvantage in that the cushioning effect under compression is not very strong, and that many layers of this material need to be utilized to provide enough cushioning, which is time-consuming and labor-intensive. Another solution currently on the market is honeycomb cardboard, which is comprised of two layers with hexagonal cells that have walls that are oriented perpendicularly between the layers. While this solution yields a high compressive strength, it is bulky to transport and store.

Therefore, expandable layered packing products are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, expandable layered product are presented including: a first layer including, a first number of support tabs each defined by a continuous cut, where each of the first number of support tabs include a fold-line disposed along a longitudinal edge of the support tab, and where each of the first number of support tabs includes attachment points disposed along each end of the number of support tabs on a top surface of the first layer; and a second layer including, a second number of support tabs each defined by a continuous cut, where each of the second number of support tabs includes a second fold-line disposed along a longitudinal edge of the support tab, where each of the second number of support tabs includes attachment points along each end of the support tab on a bottom surface of the second layer, and where the first number of support tabs is vertically aligned with and coupled with the second number of support tabs along the attachment points such that the fold-lines are on opposing longitudinal edges. In some embodiments, expandable layered products further include: a first stabilizing layer bonded along a bottom surface of the first layer. In some embodiments, expandable layered products further include: a second stabilizing layer bonded along a top surface of the second layer. In some embodiments, one or more of the first and second number of support tabs include one or more dielines disposed along and across a width of the support tabs where a process such as: creasing, perforating, and scoring is applied to the one or more dielines. In some embodiments, expandable layered products include a process such as: creasing, perforating, and scoring is applied to one or more of the first and second fold-lines.

In other embodiments, methods of expanding an expandable layered product are presented including: providing the expandable layered product, where the expandable layered product includes, a first layer including, a first number of support tabs each defined by a first layer continuous cut, where each of the first number of support tabs include a first fold-line disposed along a first longitudinal edge of the support tab, and where each of the first number of support tabs includes first attachment points disposed along each end of the first number of support tabs on a top surface of the first layer; and a second layer including, a second number of support tabs each defined by a second layer continuous cut, where each of the second number of support tabs includes a second fold-line disposed along a second longitudinal edge of the support tab, where each of the second number of support tabs include second attachment points along each end of the second number of support tabs on a bottom surface of the second layer, and where the first number of support tabs is vertically aligned with and coupled with the second number of support tabs along the first and second attachment points such that the first fold-line and the second fold-line are on opposing longitudinal edges; applying a shearing force between the first layer and the second layer; folding the first and second fold-lines in response to the applying the shearing force; and locking the first and second layers in an expanded form. In some embodiments, methods further include: a first stabilizing layer bonded along a bottom surface of the first layer and a second stabilizing layer bonded along a top surface of the second layer.

In other embodiments, expandable layered product are presented including: a first layer including, a first number of support tabs disposed on a top surface of the first layer, where each of the first number of support tabs includes a first hinge disposed along one longitudinal edge of the support tab for hingedly coupling the support tab with the top surface, and where each of the first number of support tabs includes first attachment points disposed along each end of the first number of support tabs, and a second layer having including, a second number of support tabs disposed on a bottom surface of the second layer, where each of the second number of support tabs includes a second hinge disposed along one longitudinal edge of the support tab for hingedly coupling the support tab with the bottom surface, where each of the second number of support tabs include second attachment points along each end of the second number of support tabs, and where the first number of support tabs is vertically aligned with and coupled with the second number of support tabs along the first and second attachment points such that the first hinge and the second hinge are on opposing longitudinal edges.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of an expandable layered product in accordance with embodiments of the present invention;

FIG. 2 is an illustrative representation of an expandable layered product in accordance with embodiments of the present invention;

FIG. 3 is an illustrative representation of an expandable layered product in accordance with embodiments of the present invention;

FIG. 4 is an illustrative representation of various patterns of an expandable layered product in accordance with embodiments of the present invention;

FIG. 5 is an illustrative representation of various shapes of support tabs for an expandable layered product in accordance with embodiments of the present invention;

FIG. 6 is an illustrative representation of an expandable layered product with stabilizing layers in accordance with embodiments of the present invention;

FIG. 7 is an illustrative side view representation of an expandable layered product in accordance with embodiments of the present invention;

FIG. 8 is an illustrative representation of expandable layered products in locked positions in accordance with embodiments of the present invention;

FIG. 9 is an illustrative representation of an expandable layered product in accordance with embodiments of the present invention;

FIG. 10 is an illustrative representation of an expandable layered product in accordance with embodiments of the present invention; and

FIG. 11 is an illustrative representation of an expandable layered product in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In aspects of the present invention, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Embodiments disclosed herein provide solutions that can withstand high compressive forces, are easy to manufacture, and are easy to transport. The orientation of the support tabs in the expanded configuration provides a high degree of cushioning via compressive strength. There are numerous and varied void fill applications for the embodiments disclosed such as sheet padding for an item within a box or mailer, wrapping fragile items, or filling space voids. In addition, embodiments provided herein may also be integrated onto existing packaging. As an example, embodiments could be applied to one or more faces of a packaging box so that that cushioning may be integrated into this box. Another packaging concept that is gaining traction is on-demand packaging where cushioning material, packaging envelope mailers, and boxes are produced on demand and are specifically sized to fit a shipment's contents. In this situation packaging materials such as kraft paper or corrugated paper are cut and sometimes adhered on-site to fit a shipment's contents. Embodiments disclosed herein can have tremendous application in this realm when a sustainable cushion material is desired. The cushion material can be produced and expanded on site to output a cushioned sheet material, which can then be cut and adhered on-demand to fit a shipment's contents. Alternately, the tab layers may be manufactured elsewhere, and the layers may be adhered to one another and expanded on site.

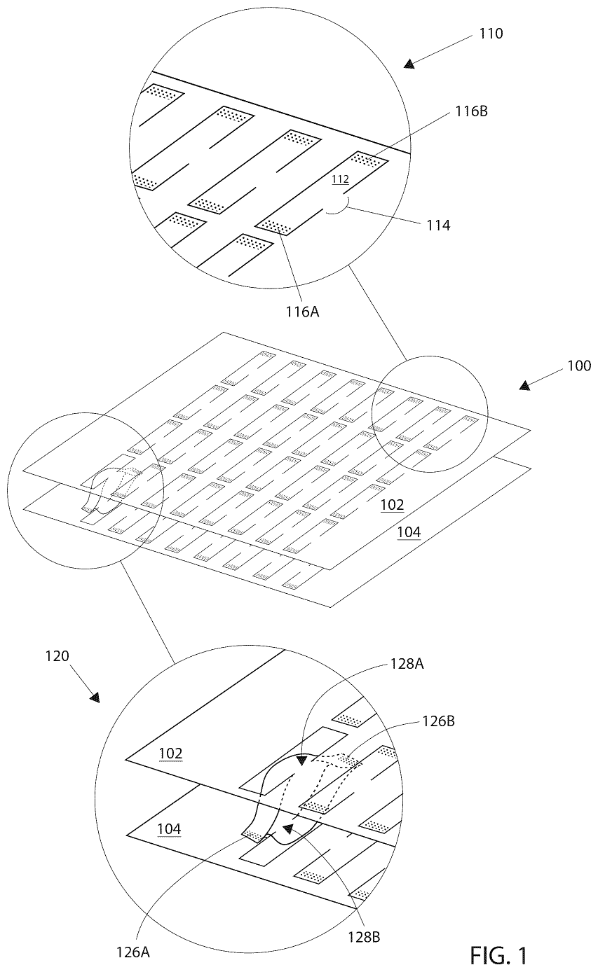

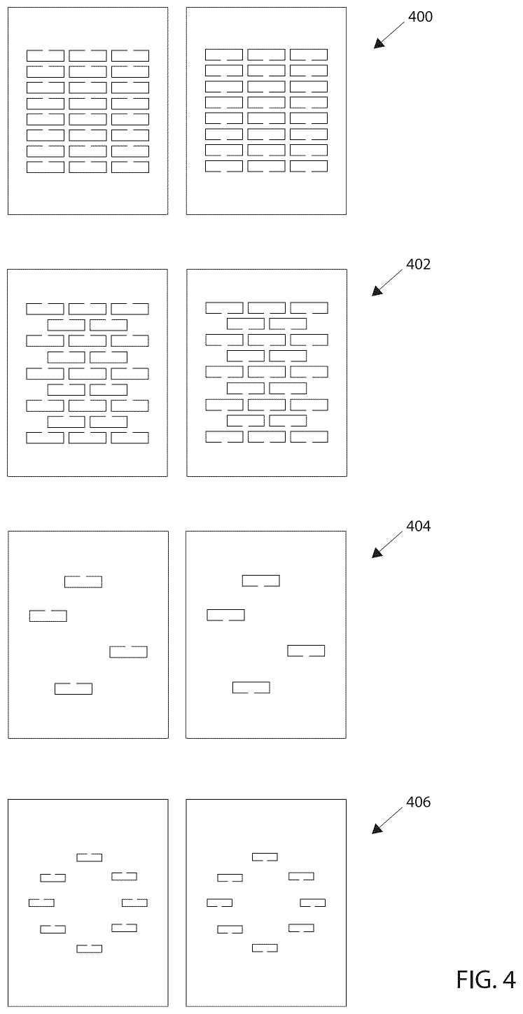

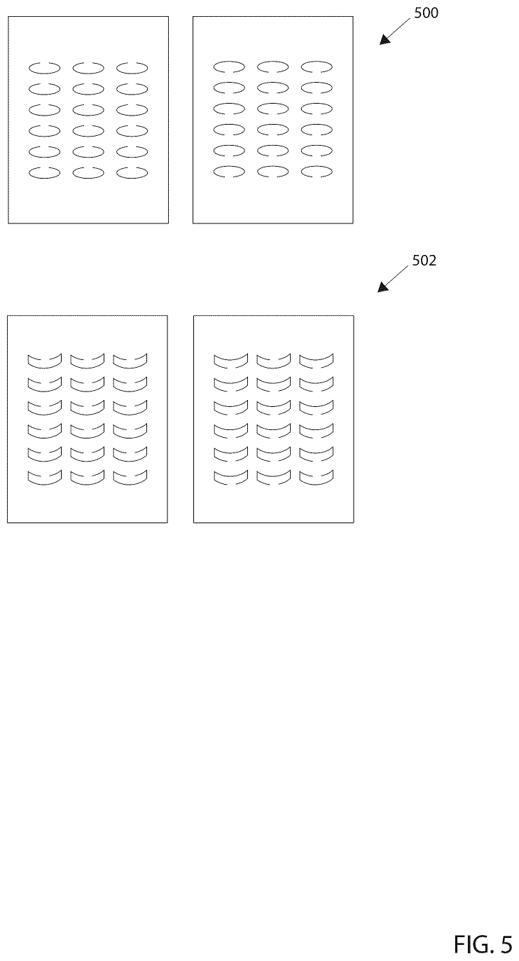

FIG. 1 is an illustrative representation of expandable layered product 100 in accordance with embodiments of the present invention. In particular, FIG. 1 illustrates magnified views 110 and 120 for clarity in disclosing embodiments provided herein. As illustrated, expandable layered product 100 includes at least two layers 102 and 104. As utilized herein, these layers may be referenced as a “top,” “bottom,” “upper,” or “lower,” layers. These terms are useful for describing embodiments illustrated but are not intended as limiting with respect to absolute positions and, as such, may be utilized interchangeably throughout. In embodiments, layers may be manufactured from any suitable material such as: a paper material, a paperboard material, a cardboard material, a corrugated cardboard material, a polymeric sheet or film material, a felt material, and a natural fibrous material without limitation. Each layer illustrated includes a number of support tabs 112. These support tabs are defined by a continuous cut or slit through the layer. Cutting or slitting the support tabs may be accomplished utilizing any method known in the art without departing from embodiments provided herein. Illustrated support tab 112 has a substantially rectangular shape. However, other shapes are contemplated and will be discussed in further detail below for FIG. 5. In some embodiments, the longitudinal width to height ratio of the support tabs is in a range of approximately 2:1 to 11:1. In addition, the illustrated support tabs are organized in a grid pattern. Other patterns are contemplated and will be discussed in further detail below for FIG. 4.

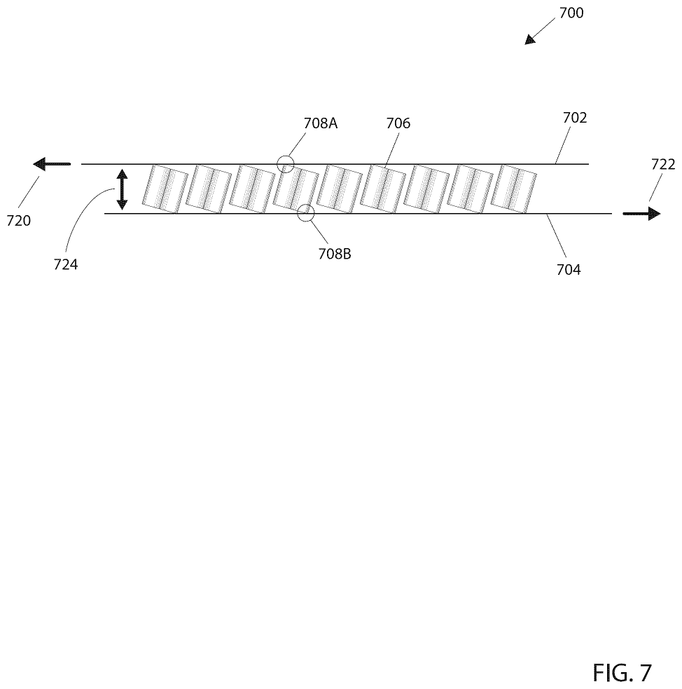

Further illustrated is fold-line 114 which maintains a connection between the layer and the support tab as well as provides a line about which folding occurs when expanding the embodiment. When a reduction in folding force is desired, the fold-line may be creased, scored, or perforated without limitation in embodiments. As illustrated, fold-line 114 is disposed along the longitudinal (or long) edge of support tab 112. In embodiments, the fold-line length is in a range of approximately 11.0 to 46.0% of the longitudinal width. Further illustrated are attachment points 116A and 116B disposed along each end of support tab 112 along the bottom surface of layer 102. In operation, the attachment points on the bottom surface of one layer are mechanically coupled with the attachments on the top surface of another layer. Attachment may be accomplished utilizing any method or material known in the art without departing from embodiment provided herein. Magnified view 120 illustrates an embodiment having attachment points coupled between layers. As illustrated, the support tabs from the top layer are vertically aligned with the support tabs from the bottom layer. When the support tabs are vertically aligned, the attachment points may be coupled. As illustrated, attachments points 126A and 126B are the points where layers 102 and 104 are coupled. In particular, the attachments points on the bottom surface of layer 102 are coupled with the attachment points on the top surface of layer 104. In addition, fold-line 128A of layer 102 and fold-line 128B of layer 104 are oriented on opposing longitudinal edges. When a shearing force is placed on the two layers, the support tabs hinge about the fold-line expanding the coupled support tabs (or support tab pairs) and resulting in a transverse force that separates the layers. Shearing and transverse forces will be discussed in further detail below for FIG. 7.

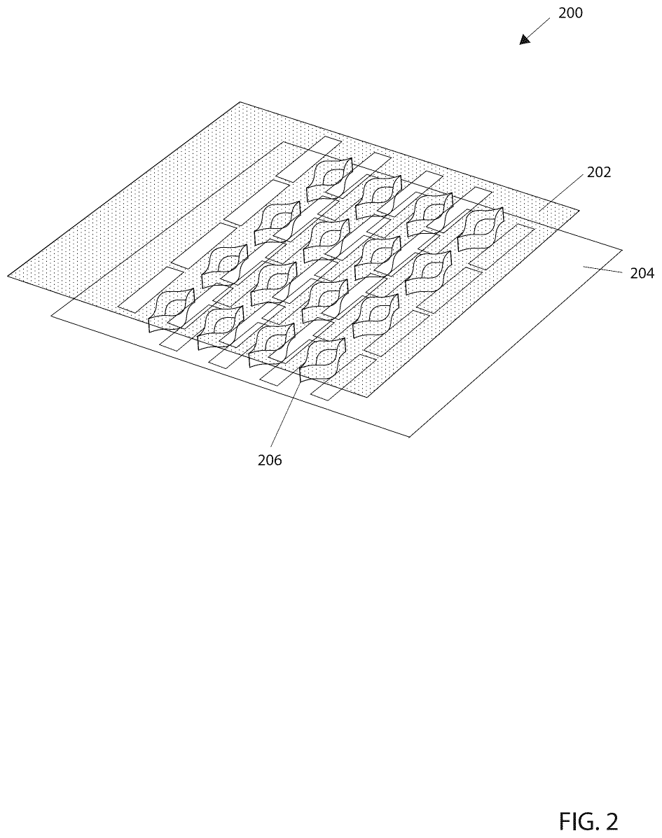

FIG. 2 is an illustrative representation of expandable layered product 200 in accordance with embodiments of the present invention. In particular, FIG. 2 illustrates an expandable layered product embodiment in the expanded configuration. As illustrated, expandable layered product 200 includes upper layer 202 and lower layer 204. Each support tab pair 206 is attached along fold-lines corresponding with both the upper layer and the lower layer. An applied shearing force activates the fold action and expands the support tab pairs into approximately the shape illustrated. When a shearing force is placed on the two layers, the support tabs hinge about the fold-line expanding the coupled support tabs and resulting in a transverse force that separates the layers.

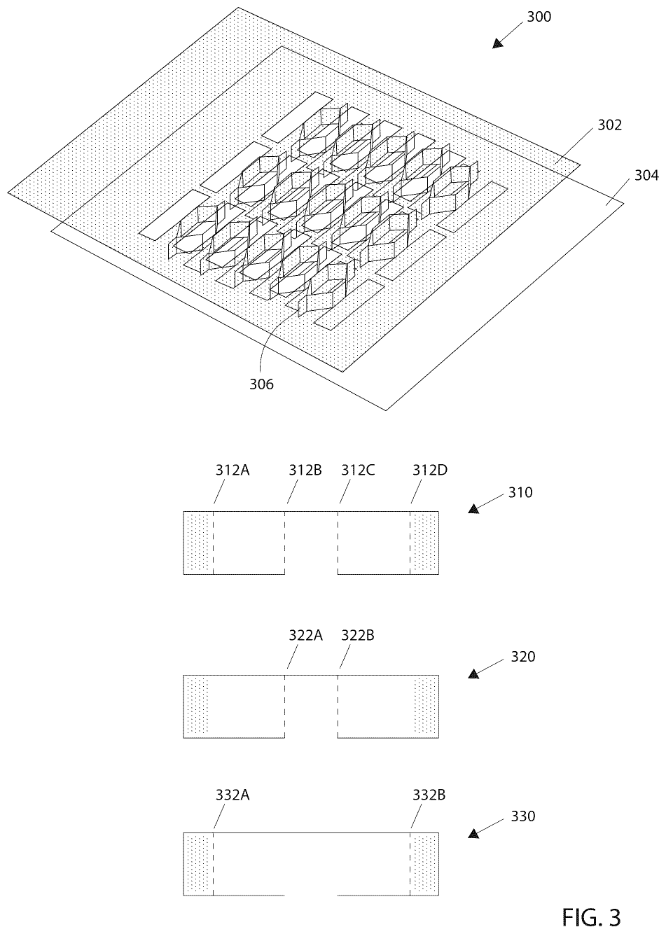

FIG. 3 is an illustrative representation of expandable layered product 300 in accordance with embodiments of the present invention. In particular, FIG. 3 illustrates an expandable layered product embodiment in the expanded configuration. As illustrated, expandable layered product 300 includes upper layer 302 and lower layer 304. Each support tab pair 306 is attached along fold-lines corresponding with both the upper layer and the lower layer. An applied shearing force activates the fold action and expands the support tab pair into approximately the shape illustrated. When a shearing force is placed on the two layers, the support tabs hinge about the fold-line expanding the coupled support tabs resulting in a transverse force that separates the layers. In some embodiments, it may be desirable for the support tabs to have additional folds that may provide increased strength to the expandable layered product. For example, support tab 310 includes dielines 312A-312D that may be provided so that the expanded shape is approximately hexagonal. In another illustrated embodiment, support tab 320 includes dielines 322A and 322B may be provided. In still another illustrated embodiment, support tab 330 includes dielines 332A and 332B may be provided. As such one or more dielines may be disposed along the width or length of a support tab without limitations. In embodiments, dielines may be creased, scored, or perforated without limitation.

FIG. 4 is an illustrative representation of various patterns of an expandable layered product in accordance with embodiments of the present invention. As noted above, various patterns of support are contemplated for embodiments disclosed herein. For example, as illustrated grid pattern 400, off-set grid pattern 402, randomized pattern 404, and pre-determined shape pattern 406 are presented. A grid pattern has some advantage in that it creates a particularly strong configuration under compression. A pre-determined shape pattern may provide advantage if an item to be packed has a specific shape or pressure points that must be accommodated. These patterns are provided to demonstrate the versatility of embodiments contemplated herein.

FIG. 5 is an illustrative representation of various shapes of support tabs for an expandable layered product in accordance with embodiments of the present invention. As noted above, various shapes of support tabs are contemplated for embodiments disclosed herein. For example, in addition to the rectangular shape disclosed above, ovate shaped support tabs 500 and arcuate shaped support tabs 502 are illustrated. Various shapes can provide different contact points and compression profiles for embodiments provided herein.

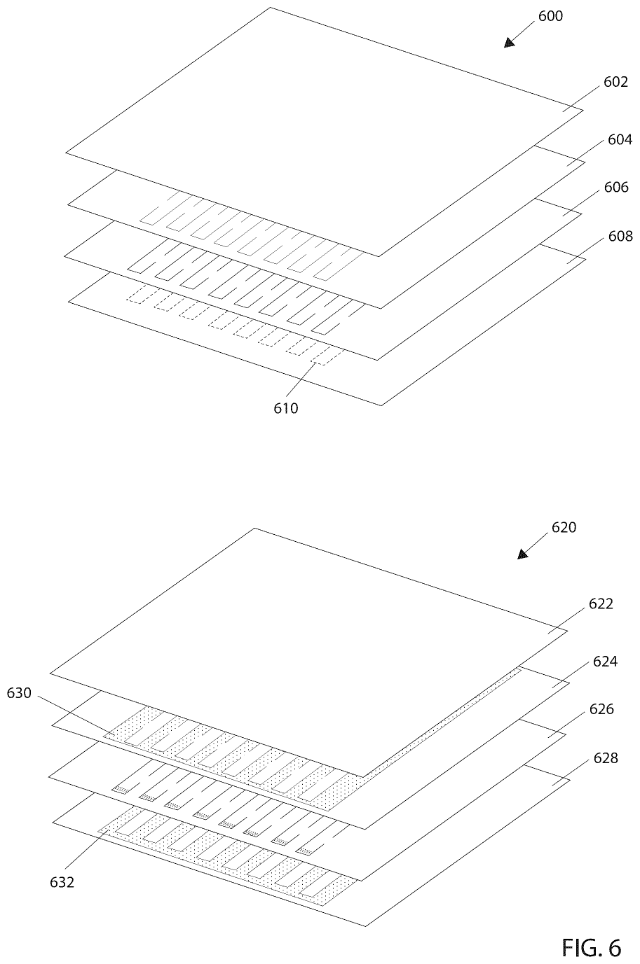

FIG. 6 is an illustrative representation of expandable layered products with stabilizing layers in accordance with embodiments of the present invention. Stabilizing layers may provide additional support to layers as disclosed above resulting in a more uniform folding and expanding of support tabs as well as adding additional rigidity to embodiments provided herein. In particular, FIG. 6 illustrates expandable layered product 600 without adhesive and expandable layered product 620 with adhesive. As such expandable layered product 600 includes layers 604 and 606 that may be supported by stabilizing layers 602 and 608 respectively. Stabilizing layers may be manufactured from any suitable material such as: a paper material, a paperboard material, a cardboard material, a corrugated cardboard material, a polymeric sheet or film material, a felt material, and a natural fibrous material without limitation. Arca 610 indicates the alignment of support tabs of layer 606 where adhesive should not be applied. As illustrated, expandable layered product 620 with adhesive includes layers 624 and 626 that may be supported by stabilizing layers 622 and 628 respectively. Adhesive areas 630 and 632 represent areas where adhesive may be utilized to bond the layers without interfering with the action of the support tabs. In some embodiments a single stabilizing layer alone may be utilized without limitation.

FIG. 7 is an illustrative side view representation of expandable layered product 700 in accordance with embodiments of the present invention. In particular, FIG. 7 illustrates the applicable forces present when expanding embodiments disclosed herein. As illustrated, expandable layered product 700 includes top layer 702 and bottom layer 704. As shearing forces 720 and 722 are applied to the layers, support tab pairs 706 rotate or fold about fold-lines 708A and 708B from a flat position to an expanded position. As the tab pairs are expanded transverse force 724 operates to expand the product.

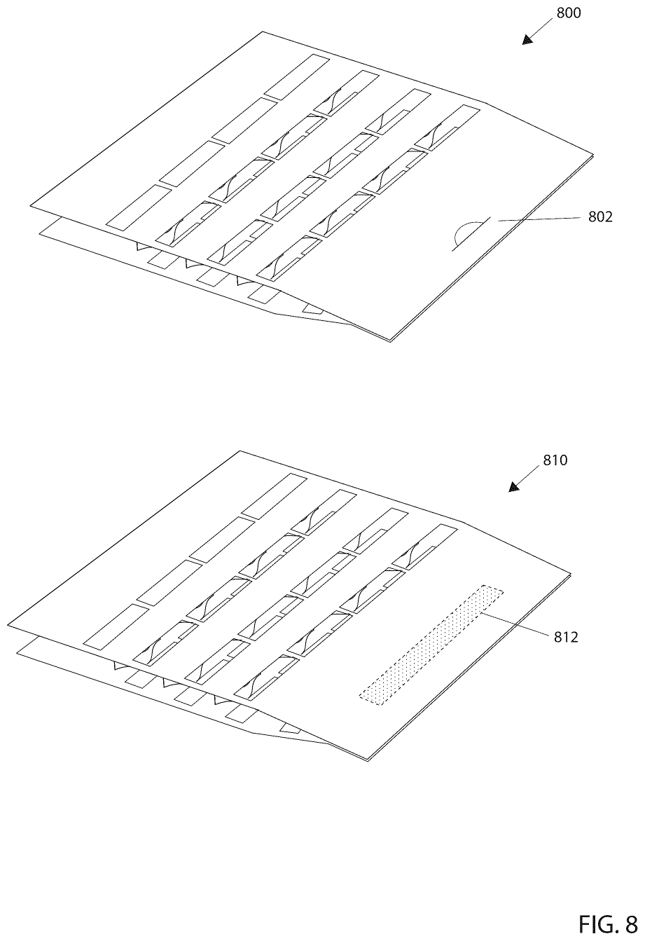

FIG. 8 is an illustrative representation of expandable layered products in locked positions in accordance with embodiments of the present invention. As illustrated, expandable layered product 800 includes a locking tab 802. In embodiments, the locking tab is formed by providing a tab cut in a first layer and a slot cut in a second layer. To lock the layers in place, the tab is inserted through the slot cut. Further illustrated is expandable layered product 810 that includes a locking strip 812. In this example, an adhesive strip is provided to lock the layers. Locking the layers together in their shifted configuration prevents the support tab pairs from collapsing.

### ALTERNATE EMBODIMENTS

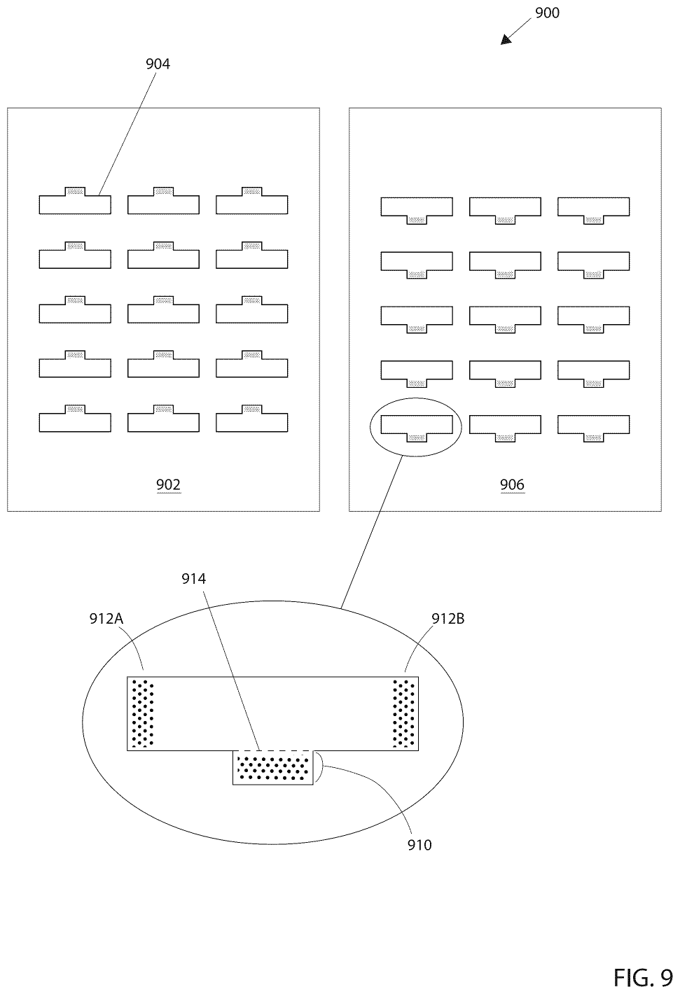

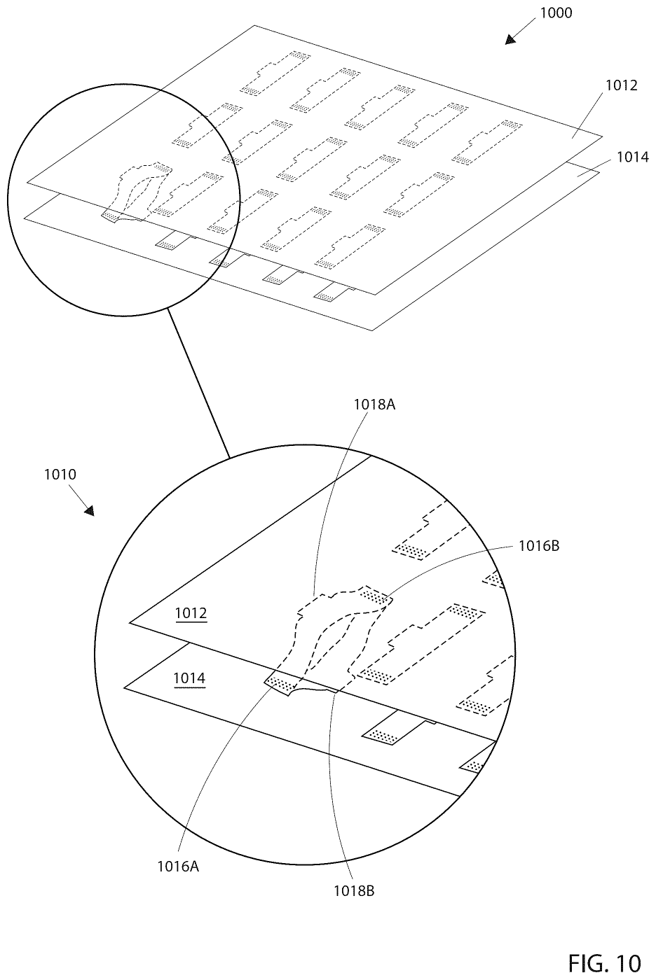

In the following discussion, FIGS. 9, 10, and 11 relate to embodiments where the support tabs are manufactured separately and coupled with the layers. FIG. 9 is an illustrative representation of an expandable layered product 900 in accordance with embodiments of the present invention. In the illustrated embodiment, a number of support tabs 904 are coupled with the surfaces of layers 902 and 906. Each support tab is coupled with a layer at hinge 910 that is disposed along a longitudinal edge of the support tab. Each support tab will be further coupled with a corresponding support tab along attachment points 912A and 912B disposed along each end of the support tab (see FIG. 10). In operation, the support tab attachment points on the bottom surface of one layer are mechanically coupled with the support tab attachment points on the top surface of another layer. Attachment may be accomplished utilizing any method or material known in the art without departing from embodiment provided herein. With the hinge coupled along the layer surface, the support tab may be folded along fold-line 914, which is disposed along the longitudinal (or long) edge of the support tab. When a reduction in folding force is desired, the fold-line may be creased, scored, or perforated without limitation in embodiments.

FIG. 10 is an illustrative representation of expandable layered product 1000 in accordance with embodiments of the present invention. Magnified view 1010 illustrates an embodiment having attachment points coupled between layers. As noted above, in operation, the support tab attachment points on the bottom surface of one layer are mechanically coupled with the support tab attachment points on the top surface of another layer. As illustrated, the support tabs from the top layer are vertically aligned with the support tabs from the bottom layer. When the support tabs are vertically aligned, the attachment points may be coupled to form a support tab pair. As illustrated, attachments points 1016A and 1016B are the points where layers 1012 and 1014 are coupled. In particular, the support tab attachment points on the bottom surface of layer 1012 are coupled with the support tab attachment points on the top surface of layer 1014. In addition, hinge 1018A of layer 1012 and hinge 1018B of layer 1014 are oriented on opposing longitudinal edges. When a shearing force is placed on the two layers, the tabs hinge about the fold-line expanding the coupled support tabs (or support tab pairs) resulting in a transverse force that separates the layers. Shearing and transverse forces are discussed in further detail above for FIG. 7.

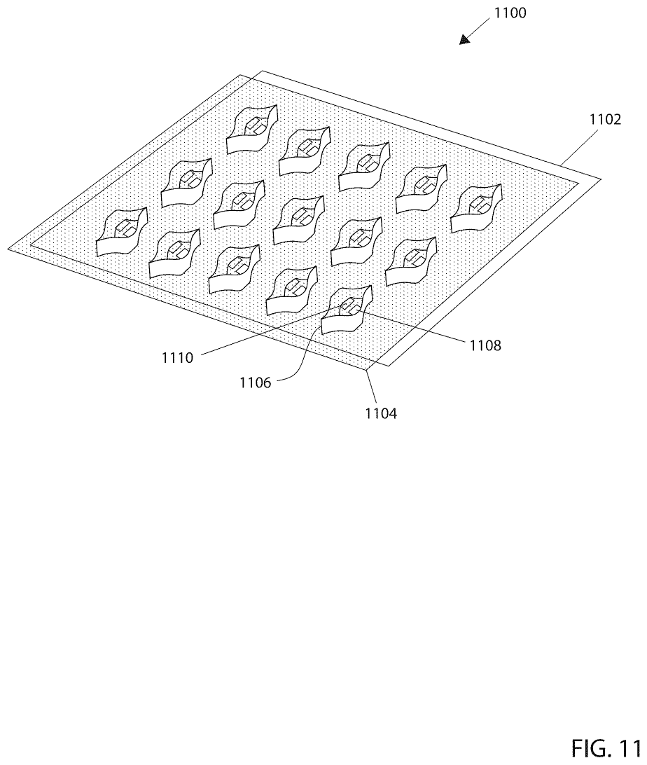

FIG. 11 is an illustrative representation of expandable layered product 1100 in accordance with embodiments of the present invention. In particular, FIG. 11 illustrates an expandable layered product embodiment in the expanded configuration. As illustrated, expandable layered product 1100 includes upper layer 1102 and lower layer 1104. Each support tab pair 1106 is attached along hinges 1110 and 1108 corresponding with the lower layer 1104 and the upper layer 1102 respectively. An applied shearing force activates the fold action and expands the support tab pair into approximately the shape illustrated. The shearing force expands the support tab pairs resulting in a transverse force that separates the layers which are then supported by the support tab pairs. Once the support tab pairs have fully rotated to a perpendicular position with respect to the layers, a relatively high degree of compressive force may be exerted on the product as the cells formed by the support tab pairs lend tremendous strength.

There are some embodiments where two sets of expanding layers may be desirable. An example of this would be a cushion mailer where one set of expanding layers would be used on the front face of the mailer and another set of mating layers would be used on the back face of the mailer. In this cushion mailer embodiment, the space between the two sets of expanding layers would allow for contents to be placed inside the cushion mailer. In these embodiments with two sets of expanding layers, there is yet another option for holding the support tab pairs in an expanded and locked position. This option is a catch system. In this scenario, some portion of the two inner layers would be cut to have some abutment that catches in a one-way direction against a glue pattern adhering the two outer layers. Thus, the inner layers can be sheared against the outer layers with the abutment passing against the glue pattern, but then unable the pass in a reverse direction as the abutment catches against the glue pattern. This method effectively holds each set of layers in an expanded configuration with the cells in an open position. This type of cushion mailer could be produced and transported in a flat state, allowing users to save space while storing the mailer. The cushion mailer could then be expanded on site as needed when utilizing the mailer to protect and ship items. Alternately, the cushion mailer could be produced and transported in its expanded state, such that the end user does not have to take the step of expanding the mailer.

While much of the focus of this disclosure is related to the products' use as a packaging or cushioning material, embodiments may also be used in applications such as a thermal barrier, a sound barrier, a light shielding, or filtering barrier. In addition, embodiments may further be used as a spatial barrier when produced on a larger scale to create a wall that can be setup and taken down quickly. The uses for embodiments are widely varied and any particular example is not intended to be limiting with respect to the broad uses of the embodiments disclosed herein.

### Methods of Manufacture

The sheet goods used to produce embodiments disclosed herein are typically available in roll form. In a high output production environment, the production process would be as follows when no stabilizing layers are present and the support tabs are formed through cuts in the film or sheet material:

Two continuous rolls of sheet material, referred to as the top web and bottom web, are mounted on roll unwinders, which feed each web into the production line under controlled tension.

Each web is directed to an individual rotary die cutters equipped with precision steel rule dies. The rotary die cutters die cut the support tabs into the web.

After the die-cutting operation, each web proceeds through a rotary pattern glue applicator. The applicator applies adhesive along the ends of the support tabs.

The top and bottom webs are then aligned using a web registration system, which may include servo-driven nip rollers, photo-eye sensors, and guidance rollers, and then brought together in a laminating nip roller assembly that presses the webs together, bonding them through the applied adhesive.

The laminated composite web is advanced to a second rotary die-cutting station, a flatbed die cutter, or an inline sheeting/slitting system, where the external perimeter of each desired unit is cut through all layers. This separates individual units from the web. The choice between rotary and flatbed depends on production speed, material thickness, and die-cutting precision.

In the case where additional stabilizing layer or layer(s) are present, backer webs are supplied from one or more additional unwind stations. A rotary glue applicator (or slot-die coater for higher precision) applies adhesive to either the backer surface or the laminated composite (main layer sheets with support tabs) with glue sited along areas outside of the support tab cuts, such that the support tabs are still free to hinge. The backer layer is applied to the exterior surface of the composite structure using a laminating roller system or nip roller press. In this situation, the fully laminated and backer-applied web is sent to a final die-cutting station or sheeting unit, where each finished unit is cut to the desired size.

In the case where scores, creases or perforations are desired on the support tabs, the rotary die cutter described above which cuts the support tabs, can integrate dielines using scoring rules, creasing rules, or perforation rules to create scores, creases or perforations on the support tabs. Other manufacturing means readily understood by those skilled in the art may also be applied as there are multiple means of cutting, gluing and laminating the layers.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. An expandable layered product comprising:
a first layer comprising,
a first plurality of support tabs each defined by a first layer continuous cut, wherein
each of the first plurality of support tabs comprise a first fold-line disposed along a first longitudinal edge of the support tab, and wherein
each of the first plurality of support tabs comprises first attachment points disposed along each end of the support tab on a top surface of the first layer; and
a second layer comprising,
a second plurality of support tabs each defined by a second layer continuous cut, wherein
each of the second plurality of support tabs comprises a second fold-line disposed along a second longitudinal edge of the support tab, wherein
each of the second plurality of support tabs comprise second attachment points along each end of the support tab on a bottom surface of the second layer, and wherein
the first plurality of support tabs is vertically aligned with and coupled with the second plurality of support tabs along the first and second attachment points such that the first fold-line and the second fold-line are on opposing longitudinal edges.

2. The expandable layered product of claim 1, further comprising:
a first stabilizing layer bonded along a bottom surface of the first layer.

3. The expandable layered product of claim 2, further comprising:
a second stabilizing layer bonded along a top surface of the second layer.

4. The expandable layered product of claim 1, wherein
one or more of the first and second plurality of support tabs comprise one or more dielines disposed along and across a width of the support tabs.

5. The expandable layered product of claim 4, wherein a process selected from the group consisting of: creasing, perforating, and scoring is applied to the one or more dielines.

6. The expandable layered product of claim 1, wherein the first and second plurality of support tabs are a shape selected from the group consisting of: a rectangular shape, an arcuate shape, and an ovate shape.

7. The expandable layered product of claim 1, wherein the first and second plurality of support tabs form a pattern selected from the group consisting of: a grid pattern, an offset grid pattern, a pre-determined shape pattern, and a randomized pattern.

8. The expandable layered product of claim 1, wherein a process selected from the group consisting of: creasing, perforating, and scoring is applied to one or more of the first and second fold-lines.

9. The expandable layered product of claim 1, wherein the first layer and the second layer are each manufactured from a material selected from the group consisting of: a paper material, a paperboard material, a cardboard material, a corrugated cardboard material, a polymeric sheet or film material, a felt material, and a natural fibrous material.

10. A method of expanding an expandable layered product comprising:
providing the expandable layered product, wherein the expandable layered product comprises,
a first layer comprising,
a first plurality of support tabs each defined by a first layer continuous cut, wherein
each of the first plurality of support tabs comprise a first fold-line disposed along a first longitudinal edge of the support tab, and wherein
each of the first plurality of support tabs comprises first attachment points disposed along each end of the first plurality of support tabs on a top surface of the first layer; and
a second layer comprising,
a second plurality of support tabs each defined by a second layer continuous cut, wherein
each of the second plurality of support tabs comprises a second fold-line disposed along a second longitudinal edge of the support tab, wherein
each of the second plurality of support tabs comprise second attachment points along each end of the second plurality of support tabs on a bottom surface of the second layer, and wherein
the first plurality of support tabs is vertically aligned with and coupled with the second plurality of support tabs along the first and second attachment points such that the first fold-line and the second fold-line are on opposing longitudinal edges;
applying a shearing force between the first layer and the second layer;
folding the first and second fold-lines in response to the applying the shearing force; and
locking the first and second layers in an expanded form.

11. The expandable layered product of claim 10, further comprising:
a first stabilizing layer bonded along a bottom surface of the first layer.

12. The expandable layered product of claim 11, further comprising:
a second stabilizing layer bonded along a top surface of the second layer.

13. The expandable layered product of claim 10, wherein
one or more of the first and second plurality of support tabs comprise one or more dielines disposed along and across a width of the support tabs.

14. The expandable layered product of claim 13, wherein a process selected from the group consisting of: creasing, perforating, and scoring is applied to the one or more dielines.

15. The expandable layered product of claim 10, wherein the first and second plurality of support tabs are a shape selected from the group consisting of: a rectangular shape, an arcuate shape, and an ovate shape.

16. The expandable layered product of claim 10, wherein the first and second plurality of support tabs form a pattern selected from the group consisting of: a grid pattern, an offset grid pattern, a pre-determined shape pattern, and a randomized pattern.

17. The expandable layered product of claim 10, wherein a process selected from the group consisting of: creasing, perforating, and scoring is applied to one or more of the first and second fold-lines.

18. The expandable layered product of claim 10, wherein the first layer and the second layer are each manufactured from a material selected from the group consisting of: a paper material, a paperboard material, a cardboard material, a corrugated cardboard material, a polymeric sheet or film material, a felt material, and a natural fibrous material.

19. An expandable layered product comprising:
a first layer comprising,
a first plurality of support tabs disposed on a top surface of the first layer, wherein
each of the first plurality of support tabs comprises a first hinge disposed along one longitudinal edge of the support tab for hingedly coupling the support tab with the top surface, and wherein
each of the first plurality of support tabs comprises first attachment points disposed along each end of the first plurality of support tabs, and
a second layer having comprising,
a second plurality of support tabs disposed on a bottom surface of the second layer, wherein
each of the second plurality of support tabs comprises a second hinge disposed along one longitudinal edge of the support tab for hingedly coupling the support tab with the bottom surface, wherein
each of the second plurality of support tabs comprise second attachment points along each end of the second plurality of support tabs, and wherein
the first plurality of support tabs is vertically aligned with and coupled with the second plurality of support tabs along the first and second attachment points such that the first hinge and the second hinge are on opposing longitudinal edges.

20. The expandable layered product of claim 19, wherein
one or more of the first and second plurality of support tabs comprise one or more dielines disposed along and across a width of the support tabs, and wherein
a process selected from the group consisting of: creasing, perforating, and scoring is applied to the one or more dielines.
